(19) United States
(12) Patent Application Publication
(10) Pub. No.: US 2009/0012218 A1
(43) Pub. Date: Jan. 8, 2009

(54) SILICONE PRESSURE-SENSITIVE ADHESIVE COMPOSITION HAVING ANTISTATIC PERFORMANCE AND SILICONE PRESSURE-SENSITIVE ADHESIVE TAPE

(75) Inventor: Yasuyoshi KURODA, Annaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/167,608

(22) Filed: Jul. 3, 2008

(30) Foreign Application Priority Data
Jul. 4, 2007 (JP) 2007-175783

(51) Int. Cl. C08G 77/04; C08K 3/38; C08K 3/32; C08K 3/16; C08K 5/36

(52) U.S. Cl. 524/165; 525/478; 524/401; 524/404; 524/415; 524/434; 524/167

(57) ABSTRACT

A transparent silicone pressure-sensitive adhesive composition that exhibits excellent antistatic performance, is able to maintain that excellent antistatic performance even when exposed to high temperatures for a long time, and suffers no deterioration in adhesive properties, as well as a silicone pressure-sensitive adhesive tape that uses the composition. The composition comprises: (A) a straight-chain diorganopolysiloxane, (B) a polyorganosiloxane comprising R¹₃SiO_{0.5} units and SiO₂ units, in which the molar ratio of R¹₃SiO_{0.5} units/SiO₂ units is within a range from 0.6 to 1.7 (wherein R¹ represents a monovalent hydrocarbon group of 1 to 10 carbon atoms), and (C) an ion-conductive antistatic agent, wherein the quantity of the ion-conductive antistatic agent of the component (C) is within a range from 0.01 to 5 parts by mass per 100 parts by mass of a combination of the straight-chain diorganopolysiloxane of the component (A) and the polyorganosiloxane of the component (B).

### BACKGROUND OF THE INVENTION

1. Field of the Invention

The present invention relates to a silicone pressure-sensitive adhesive composition having antistatic performance and a silicone pressure-sensitive adhesive tape. More specifically, the invention relates to a transparent silicone pressure-sensitive adhesive composition that has excellent antistatic performance and is able to maintain that antistatic performance even after exposure to high temperatures over an extended period, and also relates to a silicone pressure-sensitive adhesive tape that uses this composition.

2. Description of the Prior Art

Silicone pressure-sensitive adhesive tapes exhibit excellent levels of heat resistance, cold resistance, weather resistance, electrical insulation and chemical resistance, and they are therefore used under severe conditions where other pressure-sensitive adhesives such as acrylic-based, rubber-based, urethane-based or epoxy-based pressure-sensitive adhesives would suffer from deformation or degradation.

One example of such severe conditions is an environment in which the tape is exposed to heating of 250° C. or higher. These environments are encountered, for example, during the masking or temporary securing of semiconductor components during reflow steps or resin encapsulation steps. In recent years, these heat treatments have tended to be conducted at higher temperatures than those conventionally used, and as a result, the use of highly heat-resistant silicone pressure-sensitive adhesives has increased.

However, because silicone pressure-sensitive adhesives exhibit excellent electrical insulation, when the pressure-sensitive adhesive tape is removed following completion of the step, static electricity known as peel charging tends to develop. This static electricity can cause a variety of problems, including causing dielectric breakdown of elements such as circuits, and attracting fine dust particles that cause a reduction in the yield of the element.

In order to overcome these types of problems, various methods have been proposed for producing antistatic pressure-sensitive adhesive tapes. These methods include:

(1) making the pressure-sensitive adhesive tape substrate antistatic (patent references 1 and 2),
(2) providing an antistatic layer between the pressure-sensitive adhesive layer and the pressure-sensitive adhesive tape substrate (patent references 3, 4 and 5), and
(3) making the pressure-sensitive adhesive antistatic (patent references 6, 7, 8 and 9).

In the method of (1) above, not only are the types of substrates that can be used quite limited, but because the pressure-sensitive adhesive itself exhibits excellent electrical insulation, peel charging cannot be satisfactorily prevented.

The method of (2) above increases the number of steps in the production of the pressure-sensitive adhesive tape and is therefore undesirable from a productivity viewpoint. Further, as mentioned above for the method (1), because the pressure-sensitive adhesive itself exhibits excellent electrical insulation, peel charging cannot be satisfactorily prevented.

Examples of the method (3) above include a pressure-sensitive adhesive that contains a carbon black (see patent reference 6), a pressure-sensitive adhesive that contains a polyol (see patent reference 7), and pressure-sensitive adhesives that contain fine conductive particles dispersed therein (see patent reference 8 and 9).

However, none of these methods are satisfactory in terms of achieving favorable transparency and in terms of other factors. The adherend requires a certain level of quality, and in order to enable this quality level to be ascertained without removing the pressure-sensitive adhesive tape, a transparent pressure-sensitive adhesive layer is required.

In those cases where a polyether polyol compound is used, not only does the polyether decompose at high temperatures, meaning the antistatic effect cannot be maintained, but other problems also arise, including poor compatibility with the silicone pressure-sensitive adhesive, clouding of the pressure-sensitive adhesive, separation of the polyether polyol compound over time, and an inability to achieve the required level of adhesive properties because of the need to add a large quantity of the polyether polyol compound. When a carbon black is used, not only is an enormous amount of effort required to clean the pressure-sensitive adhesive tape apparatus and remove unwanted carbon during the production of the pressure-sensitive adhesive tape, but other problems also arise, including the fact that the external appearance of the tape is an opaque black, instability in the surface resistivity, and transfer of carbon to the adherend such as an element when the pressure-sensitive adhesive tape is removed following completion of the process. Furthermore, in those cases where fine conductive particles are used, not only does the pressure-sensitive adhesive become opaque, but the difference in specific gravity between the pressure-sensitive adhesive composition and the fine conductive particles tends to cause the fine particle conductive particles to separate out, meaning the desired performance cannot be achieved.

[Patent Reference I] JP 04-216887 A

[Patent Reference 2] JP 2003-306654 A

[Patent Reference 3] JP 63-380 A

[Patent Reference 4] JP 04-135791 A

[Patent Reference 5] JP 06-220408 A

[Patent Reference 6] U.S. Pat. No. 4,749,612

[Patent Reference 7] JP 2005-154491 A

[Patent Reference 8] JP 2004-091703 A

[Patent Reference 9] US 2004/0041131 A1

### SUMMARY OF THE INVENTION

The present invention takes the circumstances described above into consideration, and has an object of providing a transparent silicone pressure-sensitive adhesive composition that exhibits excellent antistatic performance, is able to maintain that excellent antistatic performance even when exposed to high temperatures for a long time, and suffers no deterioration in adhesive properties. Another object of the present invention is to provide a silicone pressure-sensitive adhesive tape that uses the composition.

As a result of intensive investigation aimed at achieving the above objects, the inventors of the present invention discovered that when a composition prepared by adding a specific quantity of an ion-conductive antistatic agent to a conventional silicone pressure-sensitive adhesive composition was used to form a silicone pressure-sensitive adhesive tape, the resulting tape exhibited excellent antistatic performance, was able to maintain the antistatic performance even when exposed to a high temperature for a long time, was transparent, suffered no deterioration in adhesive properties, and could be used very favorably, and they were therefore able to complete the present invention.

Accordingly, the present invention provides an antistatic silicone pressure-sensitive adhesive composition comprising:

(A) a straight-chain diorganopolysiloxane,
(B) a polyorganosiloxane comprising R¹₃SiO_{0.5} units and SiO₂ units, in which the molar ratio of R¹₃SiO_{0.5} units/SiO₂ units is within a range from 0.6 to 1.7 (and wherein R¹ represents a monovalent hydrocarbon group of 1 to 10 carbon atoms), and
(C) an ion-conductive antistatic agent, wherein

the quantity of the ion-conductive antistatic agent of the component (C) is within a range from 0.01 to 5 parts by mass per 100 parts by mass of the combination of the straight-chain diorganopolysiloxane of the component (A) and the polyorganosiloxane of the component (B).

Furthermore, the present invention also provides a pressure-sensitive adhesive tape comprising a plastic film, and a layer composed of a cured product of the above antistatic silicone pressure-sensitive adhesive composition laminated to at least one surface of the plastic film.

The silicone pressure-sensitive adhesive composition of the present invention is able to produce a pressure-sensitive adhesive tape that exhibits excellent antistatic performance, is able to maintain that excellent antistatic performance even when exposed to high temperatures for a long time, and suffers no deterioration in adhesive properties. This pressure-sensitive adhesive tape can be used favorably for masking electronic components, and is particularly useful in environments where the generation of static electricity is undesirable.

### DETAILED DESCRIPTION OF THE PREFERRED EMBODIMENTS

A silicone pressure-sensitive adhesive composition having antistatic performance according to the present invention is a composition prepared by adding a specific quantity of an ion-conductive antistatic agent to a silicone pressure-sensitive adhesive composition.

There are no particular restrictions on the curing mechanism employed for the silicone pressure-sensitive adhesive composition of the present invention, which may be prepared either as an organic peroxide-curable organopolysiloxane composition, or as an addition reaction-curable organopolysiloxane composition.

### [Organic Peroxide-curable Antistatic Silicone Pressure-sensitive Adhesive Composition]

An example of an antistatic silicone pressure-sensitive adhesive composition of the present invention that is an organic peroxide-curable organopolysiloxane composition is presented below.

Namely, an organic peroxide-curable antistatic silicone pressure-sensitive adhesive composition, comprising:

(A) 20 to 80 parts by mass of a straight-chain diorganopolysiloxane,
(B) 80 to 20 parts by mass of a polyorganosiloxane comprising R¹₃SiO_{0.5} units and SiO₂ units, in which the molar ratio of R¹₃SiO_{0.5} units/SiO₂ units is within a range from 0.6 to 1.7 (and wherein R¹ represents a monovalent hydrocarbon group of 1 to 10 carbon atoms),
(C) 0.01 to 5 parts by mass of an ion-conductive antistatic agent per 100 parts by mass of the combination of the components (A) and (B), and
(D) 0.1 to 5.0 parts by mass of an organic peroxide curing agent per 100 parts by mass of the combination of the components (A) and (B).

More detailed descriptions of the components (A) to (D) are presented below.

### <Component (A)>

The component (A) is an essentially straight-chain diorganopolysiloxane, and is preferably a diorganopolysiloxane represented by a formula (1) or formula (2) shown below.

R²₃SiO—(R²₂SiO)ₚ—SiR²₃ (1)

R²₂(OH)SiO—(R²₂SiO)ₚ—SiR²₂(OH) (2)

(wherein, R² represents identical or different hydrocarbon groups of 1 to 10 carbon atoms, and p represents a number that results in a viscosity at 25° C. for the diorganopolysiloxane of the formula (1) or formula (2) that is at least 500 mPa·s)

R² is preferably a monovalent hydrocarbon group of 1 to 10 carbon atoms, and specific examples include alkyl groups such as a methyl group, ethyl group, propyl group or butyl group; cycloalkyl groups such as a cyclohexyl group; and aryl groups such as a phenyl group or tolyl group, and of these, a methyl group or phenyl group is particularly desirable.

The straight-chain diorganopolysiloxane should be in the form of an oil or a gum. In the case of an oil, the viscosity of the component (A) at 25° C. is preferably at least 500 mPa·s, and is more preferably 10,000 mPa·s or greater. Viscosity values of less than 500 mPa·s are unsuitable, as the curability of the composition tends to deteriorate, and the cohesive force (holding power) of the composition also tends to decrease. Furthermore, in the case of a gum, the viscosity of a solution prepared by dissolving the gum in toluene to form a solution with a concentration of 30% is preferably not more than 100,000 mPa·s. If this viscosity exceeds 100,000 mPa·s, then the composition tends to become overly viscous, and mixing the composition during production becomes difficult. The component (A) may also use a combination of two or more different materials.

### <Component (B)>

The component (B) is a polyorganosiloxane comprising R¹₃SiO_{0.5} units (wherein, R¹ represents a monovalent hydrocarbon group of 1 to 10 carbon atoms) and SiO₂ units, in which the molar ratio of R¹₃SiO_{0.5} units/SiO₂ units is within a range from 0.6 to 1.7. If the molar ratio of R¹₃SiO_{0.5} units/SiO₂ units is less than 0.6, then the adhesive strength and tack of the composition may deteriorate, whereas if the ratio exceeds 1.7, the adhesive strength and the holding power may decrease. Examples of R¹ include alkyl groups such as a methyl group, ethyl group, propyl group or butyl group; cycloalkyl groups; phenyl groups; and alkenyl groups such as a vinyl group, allyl group or hexenyl group, and of these, a methyl group is preferred.

The component (B) may contain OH groups, and the OH group content is preferably not more than 4.0% by mass. Polyorganosiloxanes in which the OH group content exceeds 4.0% by mass are undesirable as the curability of the pressure-sensitive adhesive tends to deteriorate. Furthermore, at least one of R¹SiO_{1.5} units and R¹₂SiO units may also be included within the component (B), provided they are included at levels that do not impair the properties of the composition of the present invention. The component (B) may also use a combination of two or more different compounds.

The components (A) and (B) may be used in the form of a simple mixture of the two components, or in those cases where a compound of the above formula (2) is used as the component (A), a condensation reaction product of the component (A) and the component (B) may be used. This condensation reaction may be conducted by dissolving the mixture of the component (A) and the component (B) in a solvent such as toluene, and then reacting the two components using an alkaline catalyst, either at room temperature or under reflux.

The blend ratio between the components (A) and (B), expressed as a mass ratio, is preferably within a range from 20/80 to 80/20, and is preferably from 30/70 to 70/30. If the blend quantity of the diorganopolysiloxane of the component (A) yields a ratio lower than 20/80, then the adhesive strength and the holding power tend to decrease, whereas if the ratio exceeds 80/20, then the adhesive strength and tack may deteriorate.

### <Component (C)>

The antistatic agent of the component (C) that is included in the silicone pressure-sensitive adhesive composition of the present invention is preferably not an electron-conductive material like carbon black, but rather an ion-conductive material. There are no particular restrictions on the component (C), provided it is an ion-conductive material, but lithium salts are particularly preferred.

Specific examples include LiBF₄, LiClO₄, LiPF₆, LiAsF₆, LiSbF₆, LiSO₃CF₃, LiN(SO₂CF₃)₂, LiSO₃C₄F₉, LiC(SO₂CF₃)₃, and LiB(C₆H₅)₄. These materials may be used either alone, or in combinations of two or more different materials.

One example of a method of preparing the composition of the present invention involves preparing a composition composed of the component (A), the component (B) and any other optional components that may be added, and then adding the component (C) to this composition. There are no particular restrictions on the form in which the component (C) is added, and the component (C) may be simply added in a neat form, may be diluted in an organic solvent prior to addition, or may be dispersed within a silicone oil to form a paste. Generally, adding the component (C) in a dissolved state in an organic solvent having a plurality of oxyalkylene groups within each molecule is preferred. By dissolving the component (C) in an organic solvent, the ion-conductive antistatic agent can be dispersed more uniformly within the pressure-sensitive adhesive composition. Moreover, an organic solvent having a plurality of oxyalkylene groups within each molecule forms an ion conduction pathway for the lithium ions within the lithium salt, enabling the lithium ions to migrate into the pressure-sensitive adhesive.

As a result, the ion conductivity within the pressure-sensitive adhesive improves, thereby enhancing the antistatic effect.

### <Organic Solvent for Component (C)>

There are no particular restrictions on the aforementioned organic solvent having oxyalkylene groups within the molecule, provided the solvent includes a plurality of oxyalkylene groups within each molecule, although solvents which undergo almost no volatilization at temperatures of 180° C. or lower at normal pressure are preferred. If the solvent volatilizes at a temperature of 180° C. or lower, then the solvent may volatilize during the step of curing the pressure-sensitive adhesive, and not remain within the cured product of the silicone pressure-sensitive adhesive, resulting in an unsatisfactory antistatic effect.

Examples of the organic solvent having oxyalkylene groups within the molecule include solvents of the general formulas (3) and (4) shown below, although the present invention is not restricted to these solvents.

R³—(C═O)—O—(R⁴—O)ₘ—R⁵ (3)

(wherein, R³ represents an alkyl group of 1 to 12 carbon atoms, R⁴ represents identical or different polymethylene groups of 1 to 8 carbon atoms, R⁵ is a hydrogen atom or an alkyl group of 1 to 12 carbon atoms, and m represents an integer from 2 to 50)

R⁶—(O—R⁷)ₙ—O—(C═O)—R⁸—(C═O)—O—(R⁷—O)ₚ—R⁶ (4)

(wherein, R⁶ may be identical or different and each represent a hydrogen atom or an alkyl group of 1 to 12 carbon atoms, R⁷ and R⁸ each may be identical or different and each represent an ethylene group or a polymethylene group of 3 to 12 carbon atoms, and n and p each represent identical or different integers from 2 to 50)

Examples of the alkyl group represented by R³, R⁵ or R⁶ include, e.g., alkyl groups of 1 to 12 carbon atoms such as a methyl group, ethyl group, propyl group or butyl group. Examples of the polymethylene groups represented by R⁷ and R⁸ include, e.g., those of 3 to 12 carbon atoms such as a trimethylene or tetramethylene group.

Specific examples of the organic solvents represented by the general formula (3) include butoxyethoxyethyl acetate and ethoxybutoxyethyl acetate.

Specific examples of the organic solvents represented by the general formula (4) include di(ethoxybutoxyethyl) adipate, di(ethoxybutoxybutyl) azelate, di(butoxyethoxyethyl) adipate, and di(ethoxyethoxyethyl) adipate.

Of the organic solvents represented by the general formulas (3) and (4), particularly preferred organic solvents include di(butoxyethoxyethyl) adipate and di(ethoxybutoxyethyl) adipate.

The lithium salt is blended into the organic solvent having a plurality of oxyalkylene groups within each molecule in a quantity within a range from 0.1 to 50% by mass. If this blend quantity is less than 0.1% by mass, then a satisfactory antistatic effect is not realized, whereas if the blend quantity exceeds 50% by mass, the antistatic effect becomes saturated, and the composition becomes unviable from a cost perspective.

Furthermore, in the present invention, other ion-conductive materials different from those described above, and other organic polymer-based antistatic agents such as polyethers may be used in combination with the ion-conductive antistatic agent described above, provided the addition of these other materials does not impair the performance of the silicone pressure-sensitive adhesive composition of the present invention.

The quantity added of the component (C) is typically within a range from 0.01 to 5 parts by mass, preferably from 0.02 to 3 parts by mass, and most preferably from 0.1 to 2 parts by mass, per 100 parts by mass of the combination of the component (A) and the component (B). If the quantity of the component (C) is less than 0.01 parts by mass, then the antistatic effect is inadequate, whereas if the quantity exceeds 5 parts by mass, the compatibility of the component (C) with the silicone pressure-sensitive adhesive worsens, the external appearance of the pressure-sensitive adhesive composition tends to become cloudy, and the adhesive properties tend to deteriorate as indicated by a decrease in the adhesive strength.

### <Component (D)>

The component (D) is an organic peroxide curing agent, and specific examples include dibenzoyl peroxide, 4,4′-dimethyldibenzoyl peroxide, 3,3′-dimethyldibenzoyl peroxide, 2,2′-dimethyldibenzoyl peroxide, 2,2′,4,4′-tetrachlorodibenzoyl peroxide, and cumyl peroxide.

The blend quantity of the component (D) is typically within a range from 0.1 to 5 parts by mass per 100 parts by mass of the combination of the component (A) and the component (B), and this quantity is preferably within a range from 1 to 4 parts by mass. If this quantity is less than 0.1 parts by mass, then the curability and holding strength of the composition may deteriorate. In contrast, if the quantity exceeds 5 parts by mass, then the pressure-sensitive adhesive layer may become colored, and the holding strength may deteriorate. There are no particular restrictions on the form in which the component (D) is added. The component (D) may be simply added in a neat form, may be diluted in an organic solvent prior to addition, or may be dispersed within water or a silicone oil to form a paste. The component (D) may also use a combination of two or more different compounds.

### [Addition Reaction-Curable Antistatic Silicone Pressure-Sensitive Adhesive Composition]

An example of an antistatic silicone pressure-sensitive adhesive composition of the present invention that is an addition reaction-curable organopolysiloxane composition is presented below.

Namely, an addition reaction-curable antistatic silicone pressure-sensitive adhesive composition, comprising:

(A′) 20 to 80 parts by mass of a straight-chain diorganopolysiloxane containing two or more alkenyl groups within each molecule,
(B) 80 to 20 parts by mass of a polyorganosiloxane comprising R¹₃SiO_{0.5} units and SiO₂ units, in which the molar ratio of R¹₃SiO_{0.5} units/SiO₂ units is within a range from 0.6 to 1.7 (and wherein R¹ represents a monovalent hydrocarbon group of 1 to 10 carbon atoms),
(C) 0.01 to 5 parts by mass of an ion-conductive antistatic agent per 100 parts by mass of the combination of the components (A′) and (B),
(E) a polyorganosiloxane containing SiH groups, in sufficient quantity that the molar ratio of SiH groups within the component (E) relative to alkenyl groups within the component (A′) is within a range from 0.5 to 20,
(F) 0 to 8.0 parts by mass of a reaction retarder per 100 parts by mass of the combination of the components (A′) and (B), and
(G) a platinum-based catalyst, in sufficient quantity that the mass of platinum relative to the combined mass of the components (A′) and (B) is within a range from 1 to 5,000 ppm.

More detailed descriptions of the components (A′) to (G) are presented below.

### <Component (A′)>

The component (A′) is an essentially straight-chain diorganopolysiloxane that contains alkenyl groups, and is preferably a compound represented by the formula (5) or (6) shown below.

R⁷₍₃₋ₐ₎XₐSiO—(R⁷XSiO)ₘ—(R⁷₂SiO)ₙ—SiR⁷₍₃₋ₐ₎Xₐ (5)

R⁷₂(HO)SiO—(R⁷XSiO)ₘ₊₂—(R⁷₂SiO)ₙ—SiR⁷₂(OH) (6)

(wherein, R⁷ represents a monovalent hydrocarbon group that contains no aliphatic unsaturated bonds, X represents an alkenyl group-containing organic group, a represents an integer from 0 to 3 and is preferably l, m represents a number of 0 or greater, and n represents a number of 100 or greater, provided that a and m are not both 0. Further, the value of m+n is a number that ensures that the viscosity at 25° C. of the diorganopolysiloxane of the formula (5) or (6) is at least 500 mPa·s)

In the above formulas, R⁷ is preferably a group of 1 to 10 carbon atoms, and specific examples include alkyl groups such as a methyl group, ethyl group, propyl group or butyl group; cycloalkyl groups such as a cyclohexyl group; and aryl groups such as a phenyl group or tolyl group, and of these, a methyl group or phenyl group is particularly desirable.

The alkenyl group-containing organic group represented by X is preferably a group of 2 to 10 carbon atoms, and specific examples include alkenyl group-containing monovalent hydrocarbon groups such as a vinyl group, allyl group, hexenyl group, octenyl group, acryloylpropyl group, acryloylmethyl group, methacryloylpropyl group, acryloyloxypropyl group, acryloyloxymethyl group, methacryloyloxypropyl group, methacryloyloxymethyl group, cyclohexenylethyl group, or vinyloxypropyl group, and of these, a vinyl group is particularly preferred from an industrial perspective.

This alkenyl group-containing straight-chain diorganopolysiloxane should be in the form of an oil or a gum.

In the case of an oil, the viscosity of the component (A′) at 25° C. is preferably at least 1,000 mPa·s, and is more preferably 10,000 mPa·s or greater. Viscosity values of less than 1,000 mPa·s are unsuitable, as the curability of the composition tends to deteriorate, and the cohesive force (holding power) of the composition also tends to decrease. Furthermore, in the case of a gum, the viscosity of a solution prepared by dissolving the gum in toluene to form a solution with a concentration of 30% is preferably not more than 100,000 mPa·s. If this viscosity exceeds 100,000 mPa·s, then the composition tends to become overly viscous, and mixing the composition during production becomes difficult. The component (A′) may also use a combination of two or more different materials.

### <Component (B)>

The component (B) is the same as that described above for the organic peroxide-curable antistatic silicone pressure-sensitive adhesive composition.

The component (B) may be either a single compound, or a combination of two or more different compounds.

The components (A′) and (B) may be used in the form of a simple mixture of the two components, or in those cases where a compound of the above formula (6) is used as the component (A′), a condensation reaction product prepared by condensing the component (A′) and the component (B) in advance may be used. This condensation reaction may be conducted by dissolving the mixture of the component (A′) and the component (B) in a solvent such as toluene, and then reacting the two components using an alkaline catalyst, either at room temperature or under reflux.

The blend ratio between the components (A′) and (B) is typically within a range from 20/80 to 80/20, and is preferably from 30/70 to 70/30. If the blend quantity of the diorganopolysiloxane of the component (A′) yields a ratio lower than 20/80, then the adhesive strength and the holding power tend to decrease, whereas if the ratio exceeds 80/20, then the adhesive strength and tack may deteriorate.

### <Component (C)>

The component (C) is an ion-conductive antistatic agent, and is as described above in relation to the organic peroxide-curable antistatic silicone pressure-sensitive adhesive composition.

### <Component (E)>

The component (E) is a cross-linking agent, and is an organohydrogenpolysiloxane containing at least two, and preferably three or more, hydrogen atoms bonded to silicon atoms within each molecule. Straight-chain, branched-chain or cyclic organohydrogenpolysiloxanes may be used.

Examples of the component (E) include the compounds represented by the formulas shown below, although the present invention is not restricted to such compounds.

H_{b}R⁸_{3-b}SiO—(HR⁸SiO)ₓ—(R⁸₂SiO)_{y}—SiR⁸_{3-b}H_{b}

(wherein, R⁸ represents a monovalent hydrocarbon group of 1 to 10 carbon atoms, b is either 0 or 1, x represents an integer of 1 or greater, and y represents an integer of 0 or greater, and x+y is a number which ensures that the viscosity at 25° C. for the organohydrogenpolysiloxane is within a range from 1 to 5,000 mPa·s. Typically, x+y is a number ranging from 1 to 500.)

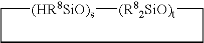

(wherein, R⁸ is as defined above, s represents an integer of 2 or greater, and t represents an integer of 0 or greater, provided that s+t≧3, and preferably 8≧s+t≧3)

The viscosity at 25° C. of this organohydrogenpolysiloxane is preferably within a range from 1 to 5,000 mPa·s, and is even more preferably from 5 to 500 mPa·s. A mixture of two or more different organohydrogenpolysiloxanes may also be used.

The quantity of the component (E) is preferably selected so that the molar ratio of SiH groups within the component (E) relative to alkenyl groups within the component (A′) is within a range from 0.5 to 20, and even more preferably from 0.8 to 15. If this ratio is less than 0.5, then the cross-linking density falls, which causes a reduction in the holding strength, whereas if the ratio exceeds 20, then the cross-linking density becomes too high, and satisfactory levels of adhesive strength and tack may be unattainable. Moreover, if the ratio exceeds 20, then the usable time span of the treatment liquid shortens.

### <Component (F)>

The component (F) is a reaction retarder, which is added to the silicone pressure-sensitive adhesive composition so that during preparation of the composition or application of the composition to a substrate, the treatment liquid does not undergo thickening or gelling prior to heat curing. Specific examples of this reaction retarder include 3-methyl-1-butyn-3-ol, 3-methyl-1-pentyn-3-ol, 3,5-dimethyl-1-hexyn-3-ol, 1-ethynylcyclohexanol, 3-methyl-3-trimethylsiloxy-1-butyne, 3-methyl-3-trimethylsiloxy-1-pentyne, 3,5-dimethyl-3-trimethylsiloxy-1-hexyne, 1-ethynyl-1-trimethylsiloxycyclohexane, bis(2,2-dimethyl-3-butynoxy)dimethylsilane, 1,3,5,7-tetramethyl-1,3,5,7-tetravinylcyclotetrasiloxane, and 1,1,3,3-tetramethyl-1,3-divinyldisiloxane.

The blend quantity of the component (F) is typically within a range from 0 to 8.0 parts by mass per 100 parts by mass of the combination of the components (A′) and (B), and quantities from 0.05 to 2.0 parts by mass are particularly preferred. If the blend quantity exceeds 8.0 parts by mass, then the curability may deteriorate.

### <Component (G)>

The component (G) is a platinum-based catalyst, examples of which include chloroplatinic acid, alcohol solutions of chloroplatinic acid, reaction products of chloroplatinic acid and an alcohol, reaction products of chloroplatinic acid and an olefin compound, and reaction products of chloroplatinic acid and a vinyl group-containing siloxane.

The quantity added of the component (G), reported as the mass of platinum relative to the combined mass of the components (A′) and (B), is typically within a range from 1 to 5,000 ppm, and is preferably from 5 to 2,000 ppm. At quantities less than 1 ppm, the curability of the composition may deteriorate, the cross-linking density may fall and the holding power may deteriorate.

The surface resistivity of the cured product may be any value that enables the product to be used as an antistatic product, but is preferably within a range from 1×10⁹ to 1×10¹⁴ ohms. The value of the surface resistivity can be measured in accordance with the method described in JIS K6911.

### <Optional Components>

Besides the components described above, other optional components may also be added to the silicone pressure-sensitive adhesive composition of the present invention. Examples of other components that can be used include unreactive polyorganosiloxanes such as polydimethylsiloxanes and polydimethyldiphenylsiloxanes, antioxidants such as phenol-based, quinone-based, amine-based, phosphorus-based, phosphite-based, sulfur-based and thioether-based antioxidants; photostabilizers such as triazole-based and benzophenone-based photostabilizers; flame retardants such as phosphate ester-based, halogen-based, phosphorus-based and antimony-based flame retardants; antistatic agents such as cationic surfactants, anionic surfactants and nonionic surfactants; and solvents for lowering the viscosity of the composition during application, including aromatic solvents such as toluene and xylene, aliphatic solvents such as hexane, octane and isoparaffin, ketone-based solvents such as methyl ethyl ketone and methyl isobutyl ketone, ester-based solvents such as ethyl acetate and isobutyl acetate, ether-based solvents such as diisopropyl ether and 1,4-dioxane, and mixtures of the above solvents.

### <Preparation of the Composition>

The composition of the present invention can be prepared by mixing together the prescribed quantities of the required components described above.

Furthermore, the composition may also be prepared by adding the ion-conductive antistatic agent of the component (C) to an existing blended composition that already contains the required components other than the component (C) (for example, a commercially available composition).

### <Substrate>

A pressure-sensitive adhesive layer can be obtained by applying the silicone pressure-sensitive adhesive composition prepared in the above manner to any of a variety of substrates, and then conducting curing under predetermined conditions.

Examples of the substrate include plastic films of polyester, polytetrafluoroethylene, polyimide, polyphenylene sulfide, polyamide, polycarbonate, polystyrene, polypropylene, polyethylene or polyvinyl chloride or the like; metal foils such as aluminum foil or copper foil; papers such as Japanese washi paper, synthetic papers or polyethylene-laminated papers; cloth; glass fiber; or composite substrates prepared by laminating a plurality of the above substrates.

In order to improve the adhesion between the substrate and the pressure-sensitive adhesive layer, a substrate that has been subjected to a preliminary primer treatment, corona treatment, etching treatment or plasma treatment may be used.

The coating method may employ conventional coating systems, and examples include a comma coater, lip coater, roll coater, die coater, knife coater, blade coater, rod coater, kiss coater, gravure coater, as well as screen coating, immersion coating and cast coating systems.

The coating quantity is preferably such that the thickness of the pressure-sensitive adhesive layer following curing is within a range from 2 to 200 μm, and preferably from 3 to 100 μm.

The curing conditions may be set to a temperature within a range from 100 to 200° C. for a period of 30 seconds to 10 minutes for a peroxide-curable composition, or to a temperature within a range from 80 to 130° C. for a period of 30 seconds to 3 minutes for an addition reaction-curable composition, although the conditions are not restricted to these ranges.

A pressure-sensitive adhesive tape may be produced by applying the composition directly to a substrate in the manner described above, or alternatively, the tape may be produced by first applying the composition of to a release film or release paper with a releasable coating provided on the surface, conducting curing of the composition, and then producing the pressure-sensitive adhesive tape by a transfer method in which the cured composition layer is bonded to an aforementioned substrate.

There are no particular restrictions on the adherend materials that can be imparted with antistatic properties using a pressure-sensitive adhesive tape produced using the silicone pressure-sensitive adhesive composition of the present invention, and examples include the materials listed below. Namely, specific examples of adherend materials include metals such as stainless steel, copper and iron; metals in which the surface of the metal has undergone a plating treatment or rustproofing treatment; ceramics such as pottery and porcelain; resins such as polytetrafluoroethylene, polyimide, epoxy resins and novolak resins; and composite materials comprising a plurality of the above materials.

### EXAMPLES

The present invention is described in more detail below using a series of examples and comparative examples, although the present invention is in no way limited by these examples. In the examples, “parts” refers to “parts by mass”, and the values reported for the various properties refer to measured values obtained using the test methods described below. Furthermore, Me represents a methyl group, and Vi represents a vinyl group.

Adhesive Strength

A solution of the organic peroxide-curable silicone pressure-sensitive adhesive composition was applied with an applicator to a polyimide film of thickness 25 μm and width 25 mm, in sufficient quantity to generate a cured layer of thickness 40 μm, and the composition was dried at 80° C. for 2 minutes and then cured by heating at 165° C. for 2 minutes, thus forming a pressure-sensitive adhesive tape.

Moreover, a solution of the addition reaction-curable silicone pressure-sensitive adhesive composition was applied with an applicator to a polyimide film of thickness 25 μm and width 25 mm, in sufficient quantity to generate a cured layer of thickness 30 μm, and the composition was then cured by heating at 130° C. for 1 minute, thus forming another pressure-sensitive adhesive tape.

Each of these pressure-sensitive adhesive tapes was bonded to a stainless steel sheet, and was then pressure bonded by rolling a 2 kg roller coated with a rubber layer once back and forth across the tape. Following standing for approximately 20 hours at room temperature, the force (N/25 mm) required to peel the pressure-sensitive adhesive tape away from the stainless steel sheet at a speed of 300 mm/minute and at an angle of 180° was measured using a tensile tester.

Surface Resistivity

The silicone pressure-sensitive adhesive composition was applied to a 110 mm-square polyimide film of thickness 25 μm and subsequently dried and cured to form a pressure-sensitive adhesive tape, using the same conditions as those described above for the measurement of the adhesive strength. The surface resistivity of this pressure-sensitive adhesive tape was then measured in accordance with JIS-K6911, using an ultra-high resistance electrical conductivity meter R8340 (manufactured by Advantest Corporation) and an applied voltage of 500 V.

External Appearance of Cured Product of Pressure-Sensitive Adhesives

A cured film of the pressure-sensitive adhesive was formed in the same manner as in the measurement of adhesive strength described above, except that a polyethylene telephtharate film was used in place of the polyimide film, and that the thickness of the cured film was changed to 40 μm, and the cured film was observed for evaluation of color and transparency.

### Example 1

A solution composed of 40 parts of a polydimethylsiloxane with the molecular chain terminals blocked with OH groups, which had a viscosity of 42,000 mPa·s when dissolved in toluene to form a solution with a concentration of 30%, 100 parts of a 60% toluene solution of a polysiloxane composed of Me₃SiO_{0.5} units and SiO₂ units (Me₃SiO_{0.5} units/SiO₂ units=0.80), and 26.7 parts of toluene was heated for 4 hours under reflux, and was then left standing to cool.

Into 100 parts of this mixture (the combined siloxane fraction within the mixture was 60%) were mixed 2.4 parts of a 50% silicone paste of benzoyl peroxide, 50 parts of toluene, and 0.6 parts of a 20% by mass adipate ester solution of LiN(SO₂CF₃)₂ as an antistatic agent, thus forming a silicone pressure-sensitive adhesive composition solution with a siloxane fraction of approximately 40%. The adhesive strength, surface resistivity and external appearance of a cured product of this silicone pressure-sensitive adhesive were measured. The results are shown in Table 1.

### Example 2

With the exception of altering the blend quantity of the 20% by mass adipate ester solution of LiN(SO₂CF₃)₂ used as the antistatic agent to 0.03 parts, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Example 3

With the exception of altering the blend quantity of the 20% by mass adipate ester solution of LiN(SO₂CF₃)₂ used as the antistatic agent to 1.5 parts, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Example 4

With the exception of altering the concentration of the adipate ester solution of LiN(SO₂CF₃)₂ used as the antistatic agent to 40%, and altering the blend quantity of the solution to 7.5 parts, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Comparative Example 1

With the exception of not adding the antistatic agent, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Comparative Example 2

With the exception of altering the blend quantity of the 20% by mass adipate ester solution of LiN(SO₂CF₃)₂ used as the antistatic agent to 0.015 parts, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Comparative Example 3

With the exception of altering the concentration of the adipate ester solution of LiN(SO₂CF₃)₂ used as the antistatic agent to 40%, and altering the blend quantity of the solution to 15 parts, a silicone pressure-sensitive adhesive composition solution was prepared in the same manner as the example 1.

The adhesive strength, surface resistivity and external appearance of a cured product of this silicone pressure-sensitive adhesive were measured. The results are shown in Table 1.

### Example 5

To a solution composed of 40 parts of a vinyl group-containing polydimethylsiloxane with the molecular chain terminals blocked with SiMe₂Vi groups, which contained 0.15 mol % of methylvinylsiloxane units and had a viscosity of 27,000 mPa·s when dissolved in toluene to form a solution with a concentration of 30%, 100 parts of a 60% toluene solution of a polysiloxane composed of Me₃SiO_{0.5} units and SiO₂ units (Me₃SiO_{0.5} units/SiO₂ units=0.80), and 26.7 parts of toluene were added 0.16 parts of a cross-linking agent with a formula shown below and 0.1 parts of ethynylcyclohexanol.

Me₃SiO—[MeHSiO]₄₀—SiMe₃

Into 100 parts of this mixture (the combined siloxane fraction within the mixture was 60%) were mixed 50 parts of toluene, 0.6 parts of a 20% by mass adipate ester solution of LiN(SO₂CF₃)₂ as an antistatic agent, and 0.5 parts of a platinum catalyst CAT-PL-50T (manufactured by Shin-Etsu Chemical Co., Ltd.), thus forming a silicone pressure-sensitive adhesive composition solution with a siloxane fraction of approximately 40%. The adhesive strength, surface resistivity and external appearance of a cured product of this silicone pressure-sensitive adhesive were measured. The results are shown in Table 1.

### Comparative Example 4

With the exception of not adding the antistatic agent, a silicone pressure-sensitive adhesive composition solution was prepared in the same manner as the example 5.

The adhesive strength, surface resistivity and external appearance of a cured product of this silicone pressure-sensitive adhesive were measured. The results are shown in Table 1.

TABLE 1

| | | External appearance of | | |
|---|---|---|---|---|
| | Parts of LiN(SO₂CF₃)₂/ | pressure-sensitive | Adhesive strength | Surface |
| | 100 parts of siloxane | adhesive cured product | (N/25 mm) | resistivity (Ω) |
| Example 1 | 0.2 | colorless, transparent | 6.0 | 3.4 × 10¹² |
| Example 2 | 0.01 | colorless, transparent | 6.1 | 4.6 × 10¹³ |
| Example 3 | 0.5 | colorless, transparent | 5.9 | 3.2 × 10¹² |
| Example 4 | 5.0 | colorless, transparent | 5.5 | 2.9 × 10¹² |
| Comparative | 0 | colorless, transparent | 6.5 | >1 × 10¹⁶ |
| example 1 | | | | |
| Comparative | 0.005 | colorless, transparent | 6.3 | >1 × 10¹⁶ |
| example 2 | | | | |
| Comparative | 10 | colorless, cloudy | 3.8 | 2.5 × 10¹² |
| example 3 | | | | |
| Example 5 | 0.2 | colorless, transparent | 10.0 | 7.6 × 10¹¹ |
| Comparative | 0 | colorless, transparent | 11.0 | >1 × 10¹⁶ |
| example 4 | | | | |

What is claimed is:

1. An antistatic silicone pressure-sensitive adhesive composition, comprising:
(A) a straight-chain diorganopolysiloxane,
(B) a polyorganosiloxane comprising R¹₃SiO_{0.5} units and SiO₂ units, in which a molar ratio of R¹₃SiO_{0.5} units/SiO₂ units is within a range from 0.6 to 1.7 (wherein R¹ represents a monovalent hydrocarbon group of 1 to 10 carbon atoms), and
(C) an ion-conductive antistatic agent, wherein
a quantity of the ion-conductive antistatic agent of component (C) is within a range from 0.01 to 5 parts by mass per 100 parts by mass of a combination of the straight-chain diorganopolysiloxane of component (A) and the polyorganosiloxane of component (B).

2. The antistatic silicone pressure-sensitive adhesive composition according to claim 1, which is an organic peroxide-curable composition, comprising:
(A) 20 to 80 parts by mass of a straight-chain diorganopolysiloxane,
(B) 80 to 20 parts by mass of a polyorganosiloxane comprising R¹₃SiO_{0.5} units and SiO₂ units, in which a molar ratio of R¹₃SiO_{0.5} units/SiO₂ units is within a range from 0.6 to 1.7 (wherein R¹ represents a monovalent hydrocarbon group of 1 to 10 carbon atoms),
(C) 0.01 to 5 parts by mass of an ion-conductive antistatic agent per 100 parts by mass of a combination of components (A) and (B), and
(D) 0.1 to 5.0 parts by mass of an organic peroxide curing agent per 100 parts by mass of a combination of components (A) and (B).

3. The antistatic silicone pressure-sensitive adhesive composition defined in claim 1, which is an addition reaction-curable composition, comprising:
(A′) 20 to 80 parts by mass of a straight-chain diorganopolysiloxane containing two or more alkenyl groups within each molecule,
(B) 80 to 20 parts by mass of a polyorganosiloxane comprising R¹₃SiO_{0.5} units and SiO₂ units, in which a molar ratio of R¹₃SiO_{0.5} units/SiO₂ units is within a range from 0.6 to 1.7 (wherein R¹ represents a monovalent hydrocarbon group of 1 to 10 carbon atoms),
(C) 0.01 to 5 parts by mass of an ion-conductive antistatic agent per 100 parts by mass of a combination of components (A′) and (B),
(E) a polyorganosiloxane containing SiH groups, in sufficient quantity that a molar ratio of SiH groups within component (E) relative to alkenyl groups within component (A′) is within a range from 0.5 to 20,
(F) 0 to 8.0 parts by mass of a reaction retarder per 100 parts by mass of a combination of components (A′) and (B), and
(G) a platinum-based catalyst, in sufficient quantity that a mass of platinum relative to a combined mass of components (A′) and (B) is within a range from 1 to 5,000 ppm.

4. The antistatic silicone pressure-sensitive adhesive composition defined in claim 1, wherein the ion-conductive antistatic agent is a lithium salt.

5. The antistatic silicone pressure-sensitive adhesive composition defined in claim 4, wherein the ion-conductive antistatic agent is one or more lithium salts selected from the group consisting of LiBF₄, LiClO₄, LiPF₆, LiAsF₆, LiSbF₆, LiSO₃CF₃, LiN(SO₂CF₃)₂, LiSO₃C₄F₉, LiC(SO₂CF₃)₃, and LiB(C₆H₅)₄.

6. A method of producing an antistatic silicone pressure-sensitive adhesive composition according to claim 1, comprising:
adding (C) an ion-conductive antistatic agent in a dissolved state in an organic solvent having a plurality of oxyalkylene groups within each molecule to a mixture containing (A) a straight-chain diorganopolysiloxane, and (B) a polyorganosiloxane comprising R¹₃SiO_{0.5} units and SiO₂ units, in which a molar ratio of R¹₃SiO_{0.5} units/SiO₂ units is within a range from 0.6 to 1.7 wherein R¹ represents a monovalent hydrocarbon group of 1 to 10 carbon atoms,
wherein a quantity of the ion-conductive antistatic agent of component (C) is within a range from 0.01 to 5 parts by mass per 100 parts by mass of a combination of the straight-chain diorganopolysiloxane of component (A) and the polyorganosiloxane of component (B).

7. A pressure-sensitive adhesive tape, comprising a plastic film, and a layer composed of a cured product of the antistatic silicone pressure-sensitive adhesive composition defined in claim 1 laminated to at least one surface of the plastic film.

8. The pressure-sensitive adhesive tape according to claim 7, wherein the layer composed of a cured product is transparent.
